(19) United States
(12) Patent Application Publication
(10) Pub. No.: US 2014/0244043 A1
(43) Pub. Date: Aug. 28, 2014

(54) COMBINATION CONTROLLER

(71) Applicant: TROLEX CORPORATION, Elmwood Park, NJ (US)

(72) Inventor: Richard Foster, Hilton Head, SC (US)

(73) Assignee: TROLEX CORPORATION, Elmwood Park, NJ (US)

(21) Appl. No.: 14/193,400

(22) Filed: Feb. 28, 2014

Related U.S. Application Data
(60) Provisional application No. 61/770,573, filed on Feb. 28, 2013.

(51) Int. Cl. G05D 27/02

(52) U.S. Cl. CPC G05D 27/02
USPC 700/276

(57) ABSTRACT

The present invention is an interactive control device that combines both functions of lighting and temperature control in one device. The interactive control device includes a thermometer and has power connections compatible to the line voltage wiring (typically 110-120 VAC) so that it may be connected to the electrical wiring in the same manner as a standard light switch. The interactive control device may also include sensors and/or cameras, or the ability to communicate with external sensors and/or cameras. The interactive control device is further capable of wirelessly communicating with remote devices, such as smart phones and tablets, appliances, alarm systems, sound systems, and locks.

### CROSS-REFERENCE TO RELATED APPLICATION

This non-provisional application claims priority from pending provisional Application No. 61/770,573 filed in the United States Patent and Trademark Office on Feb. 28, 2013.

### BACKGROUND

Every home has a light switch to turn on and off the lights in a room. Every home also has a thermostat to control the temperature in the home. Typically these devices operate on different voltages; a light switch operates on line voltage (110-120 VAC) and the thermostat on a lower voltage (24 VAC). Traditionally thermostats required this lower voltage because the sensing elements required a specific voltage to accurately sense the temperature. The advent of electronic sensors eliminates the limitation of a specific voltage for the thermostat.

### SUMMARY

The present invention is an interactive control device that combines, at a minimum, both functions of lighting and temperature control into one device. The interactive control device may also wirelessly communicate with other devices, such as the heating and cooling (HVAC) unit and local zone dampers to control the temperature and flow of air in respective zones. The interactive control device may also be used to communicate with and remotely control other devices in the home.

### BRIEF DESCRIPTION OF THE DRAWINGS

FIG. 1 depicts the control panel and typical interface, as well as HVAC equipment and registers.

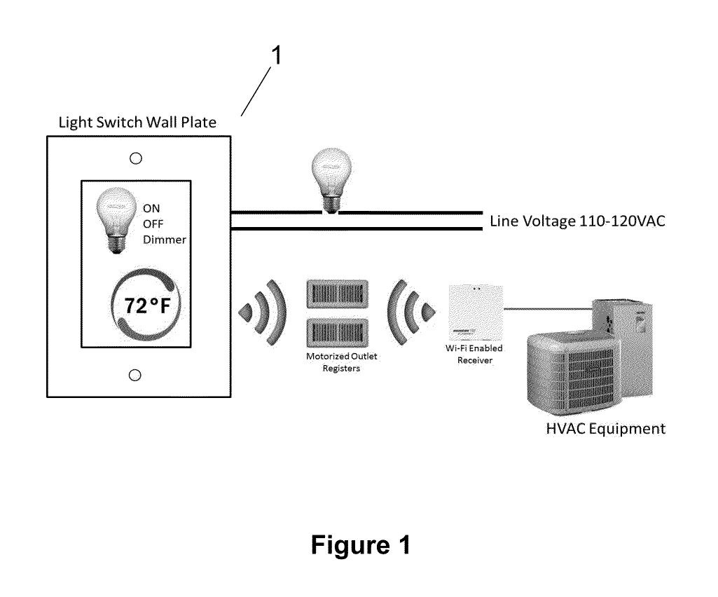

FIG. 2 depicts a side view of the control panel as installed.

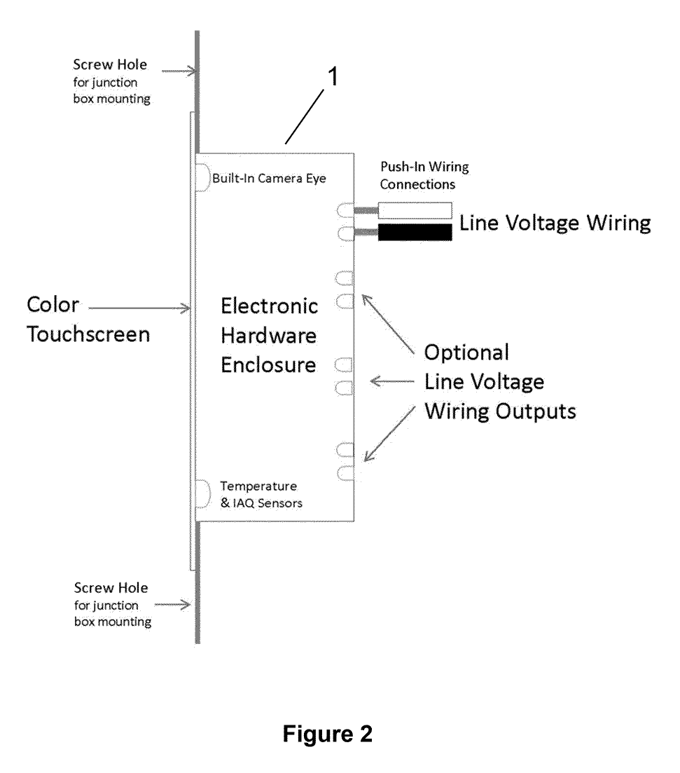

### DETAILED DESCRIPTION

The present invention is an interactive control device that combines both functions of lighting and temperature control in one device. In a preferred embodiment, the interactive control device is comprised of a control panel 1 sized to fit in the place of a typical wide-rocker light switch and has power connections compatible to the line voltage wiring (typically 110-120 VAC) so that it may be connected to the electrical wiring in the same manner as a standard light switch. Thus, the control panel 1 derives the power necessary for its operation from the line voltage wiring and steps the voltage down for operation of other devices in the control panel 1.

The control panel 1 is be capable of turning on and off the light, sensing the temperature, and remotely communicating with the HVAC component(s) to control temperature. In one embodiment, the control panel 1 and HVAC component(s) have integrated software and capability to send and receive signals to allow for communication between the devices. For example, Wi-Fi or bluetooth capability allows the interactive control device to communicate with and control the boiler/furnace, zone dampers, valves, registers, and alarms.

The control panel 1 may have a keyboard or touchscreen interface for programming and receiving user instructions. It may also be capable of programming and receiving user instructions via voice recognition. The control panel 1 may also communicate with and receive user instruction from other remote devices, such as smartphones and tablets. The control panel 1 is capable of transmitting user instructions to other devices and appliances. Wireless communication between the control panel 1 and other devices and appliances is accomplished through currently known technology, such Wi-Fi and Bluetooth.

In addition to sensing temperature and wirelessly controlling the HVAC devices, the control panel 1 may include sensors, or the ability to communicate with external sensors, which allow it to monitor humidity, carbon monoxide, carbon dioxide, and other gases and be programmed to adjust ventilation settings or activate an alarm when certain threshold levels are reached. The control panel 1 may also include a sensor, or the ability to communicate with external sensors, which detects room occupancy and be programmed to adjust the lighting and temperature accordingly. In addition, the control panel 1 may incorporate a camera, or the ability to communicate with a camera, to enable remote monitoring of activity in the environment, typically activity in a given room. The control panel 1 may be capable of transmitting the measurements and information it receives from the sensor(s) and/or camera(s) to other remote devices, such as smartphones or tablets. The control panel 1 may also be designed with the appropriate software to wirelessly communicate with and control appliances, locks, alarm systems, sound systems, and other devices.

The above is a detailed description of particular embodiments of the invention. It is recognized that departures from the disclosed embodiments may be made within the scope of the invention and that obvious modifications will occur to a person skilled in the art. Those of skill in the art should, in light of the present disclosure, appreciate that many changes can be made in the specific embodiments which are disclosed herein and still obtain a like or similar result without departing from the spirit and scope of the invention. All of the embodiments disclosed and claimed herein can be made and executed without undue experimentation in light of the present disclosure.

1. An interactive control device comprised of:
a control panel which regulates at least lighting and temperature;
the control panel includes a thermometer;
the control panel is sized to fit in the place of a typical wide-rocker light switch and has power connections compatible with the line voltage wiring of a typical light switch; and,
the control panel communicates wirelessly with heating and cooling and ventilation equipment.

2. The interactive control device of claim 1 wherein a user programs and provides instructions to the control panel via a keyboard interface.

3. The interactive control device of claim 1 wherein a user programs and provides instructions to the control panel via a touchscreen interface.

4. The interactive control device of claim 1 wherein a user programs and provides instructions to the control panel via voice recognition software.

5. The interactive control device of claim 1 wherein the control panel communicates with and receives instruction wirelessly from one or more electronic devices which are controlled by a user.

6. The interactive control device of claim 5 wherein the control panel is also capable of monitoring air quality and humidity and wirelessly communicating with and controlling the heating, cooling, and ventilation equipment when a predetermined threshold level of certain air quality parameters are reached.

7. The interactive control device of claim 5 wherein the control panel is also capable of receiving information from external air quality and humidity sensors and wirelessly communicating with and controlling the heating, cooling, and ventilation equipment when a predetermined threshold level of certain air quality parameters are reached.

8. The interactive control device of claim 5 wherein the control panel includes a sensor to detect room occupancy and is programmed to adjust the lighting and temperature for that room depending on the occupancy.

9. The interactive control device of claim 5 wherein the control panel includes a camera which wirelessly transmits images or video of the environment to a remote device.

10. The interactive control device of claim 5 wherein the control panel wirelessly communicates with and controls home security devices.

11. The interactive control device of claim 5 wherein the control panel wirelessly communicates with and controls appliances.

12. The interactive control device of claim 5 wherein the control panel wirelessly communicates with and controls audio and visual entertainment systems.

13. The interactive control device of claim 1 wherein the control panel is also capable of monitoring air quality and humidity and wirelessly communicating with the heating, cooling, and ventilation equipment to adjust ventilation when a predetermined threshold level of certain air quality parameters are reached.

14. The interactive control device of claim 1 wherein the control panel is also capable of receiving information from external air quality and humidity sensors and wirelessly communicating with and controlling the heating, cooling, and ventilation equipment when a predetermined threshold level of certain air quality parameters are reached.

15. The interactive control device of claim 1 wherein the control panel includes a sensor to detect room occupancy and is programmed to adjust the lighting and temperature for that room depending on the occupancy.

16. The interactive control device of claim 1 wherein the control panel includes a camera which wirelessly transmits images or video of the environment to a remote device.

17. The interactive control device of claim 1 wherein the control panel wirelessly communicates with and controls home security devices.

18. The interactive control device of claim 1 wherein the control panel wirelessly communicates with and controls appliances.

19. The interactive control device of claim 1 wherein the control panel wirelessly communicates with and controls audio and visual entertainment systems.
